(19) United States
(12) Patent Application Publication
(10) Pub. No.: US 2011/0113443 A1
(43) Pub. Date: May 12, 2011

(54) IP TV With DRM

(76) Inventors: Xudong Yu, San Diego, CA (US); Brant L. Candelore, San Diego, CA (US)

(21) Appl. No.: 12/849,176

(22) Filed: Aug. 3, 2010

Related U.S. Application Data
(60) Provisional application No. 61/258,722, filed on Nov. 6, 2009.

(51) Int. Cl. H04N 7/16; H04N 7/167

(52) U.S. Cl. 725/28; 725/31

(57) ABSTRACT

A method of decrypting DRM encoded content in a DTV receiver involves receiving an encrypted license from a license server at the DTV receiver; providing a unique identifier for an integrated DTV SoC forming a part of the DTV television receiver; storing a secret key in an electronic fuse memory forming a part of the SoC, where the secret key is generated using an algorithm that utilizes the unique identifier for the SoC; where the received encrypted license is encrypted using the same secret key as is stored in the electronic fuse memory; decrypting the secret key using the key stored in the electronic fuse memory to produce a clear secret key; decrypting the encrypted license using the clear secret key to determine a content key; storing the license; and decrypting the DRM encoded content using the content key. This abstract is not to be considered limiting, since other embodiments may deviate from the features described in this abstract.

### CROSS REFERENCE TO RELATED DOCUMENTS

This application is related to and claims priority benefit of U.S. Provisional Patent Application No. 61/258,722 filed Nov. 6, 2010 to Yu, et al. which is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Digital rights management (DRM) is technology used by content publishers to impose limitations on the usage of digital content. One example is Windows™ WMDRM for Portable Device (WMDRM-PD) was introduced by Microsoft Corp. in 2004. WMDRM protects content by encrypting data files. Since files are encrypted, the data itself is protected. Thus, the files may be moved, archived, copied, or distributed without restriction. There is no need to hide files or make them inaccessible, or to put special protection in place when files are transmitted from system to system (to put it another way, there are no specialized operating system requirements or high security file transport mechanisms needed). However, copying a file and giving it to a friend will not enable that friend to use the file. In order to be able to use an encrypted file, users must obtain a license. This license is the primary means of exercising control over content (the encrypted file). A license is granted to a single machine; even if copied, it will not function on other machines.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example diagram depicting a portable device acquiring a license.

FIG. 2 is an example diagram of WMDRM-ND devices streaming protected content in a manner consistent with certain embodiments of the present invention.

FIG. 3 is a diagram depicting an ASF file structure consistent with certain embodiments of the present invention.

FIG. 4 is a diagram depicting an ASF data object structure consistent with certain embodiments of the present invention.

FIG. 5 is a diagram depicting a data packet structure consistent with certain embodiments of the present invention.

FIG. 6 is a diagram depicting keys generated for DRM or other security usage in a manner consistent with certain embodiments of the present invention.

FIG. 7 is an example message flow diagram depicting WMDRM private key usage in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library / dynamic load library and/or other sequence of instructions designed for execution on a computer system. The term “processor”, “controller”, “CPU”, “Computer” and the like as used herein encompasses both hard programmed, special purpose, general purpose and programmable devices and may encompass a plurality of such devices or a single device in either a distributed or centralized configuration without limitation.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Embodiments consistent with the present invention relate to a method of secured implementation of DRM on television such as for example Windows Media Digital Rights Management for Portable Device (WMDRM-PD). WMDRM protects the content of data files by encrypting the data files. A user requires a license in order to access and decrypt the encrypted data file. The license is granted to the user after a license server verifies the user. The license is encrypted by a public key of a targeted device, only the targeted device can decrypted this license and extract a content key to decrypt the content of the data file. In accord with certain implementations, an eFuse (a memory portion of a TV decoder chip) is used to store a secret key which is used to protect the WMDRM key on the device. Presently, these keys can be generated randomly so that they are unique per device.

A secured key generation and software upgrade is used. Two keys are generated from the unique ID of the device using a secured algorithm and burned in the eFuse (a fusable storage area within the TV's integrated system on a chip (SoC) DTV receiver device). Whenever a DRM server is required to send content to the device, the server inquires the device about the unique ID of the device. This unique ID is used by the server to generate the same two keys on the server side using the secured algorithm. These two keys or their derivatives can be used for local data security, authorization, secure communication etc. Whenever there is software upgrade in the device, the software image is securely downloaded and copied to flash. During first time use of an application, the WMDRM private key will be extracted from the flash and re-encrypted using one of the keys stored in the eFuse. Whenever the device needs to play the secured content, the WMDRM private key will be decrypted and used to decrypt the license and extracting the content key from the license. The secured content is decrypted using the content key and played by the device. In this method, clear WMDRM private key is only exposed in memory for a very short time resulting in high security.

Hence, certain implementations involve generation of DRM encryption keys using a unique ID i.e. the serial number of the chip/device (at the server side). During software upgrade, a one-time extraction and re-encryption of the DRM private key using the key already stored in a memory (eFuse). A clear private key can be used to decrypt the license and use the content key to extract the content.

As noted above, Digital rights management (DRM) is technology used by content publishers to impose limitations on the usage of digital content. One example is WMDRM for Portable Device (WMDRM-PD) was introduced by Microsoft in 2004. WMDRM protects content by encrypting data files. Since files are encrypted, the data itself is protected. Thus, the files may be moved, archived, copied, or distributed without restriction. There is no need to hide files or make them inaccessible, or to put special protection in place when files are transmitted from system to system (to put it another way, there are no strange operating system requirements or high security file transport mechanisms needed). However, copying a file and giving it to a friend will not enable that friend to use the file. In order to be able to use an encrypted file, users must obtain a license. This license is the primary means of exercising control over content (the encrypted file). A license is granted to a single machine; even if copied, it will not function on other machines.

Each license defines rights and restrictions on how a media can be used. For example, a video file license could contain a “right to play” and a “right to play at most 3 times”, but not a “right to copy”; it might enable these rights for the period between Oct. 26, 2009 and Oct. 28, 2009. A protected file could have multiple licenses for different users or usages.

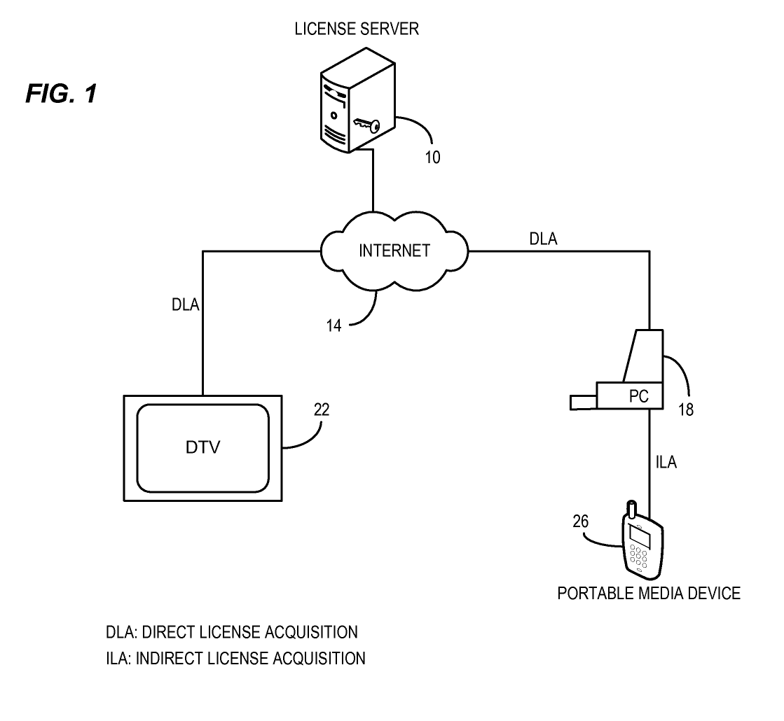

WMDRM-PD allows devices to acquire, manage, and play protected content as if they were computers. A protected content can be a file stored on a local storage and also can be a stream of content from a server on the Internet or LAN. FIG. 1 is a diagram that shows how WMDRM-PD capable devices acquire licenses.

Licenses can be acquired from a license server 10 via the Internet 14 for the case of a personal computer such as 18 using direct license acquisition (DLA). As will be described later, DLA can also be used to acquire licenses for WMDRM using DLA in a digital television (DTV) 22 such as Sony Corporation's 2009 DTV with Bravia Internet Video Link (BIVL™) using its Internet capabilities. In this illustration, a portable media device such as 26 can acquire a license from server 10 via its interconnection to PC 18.

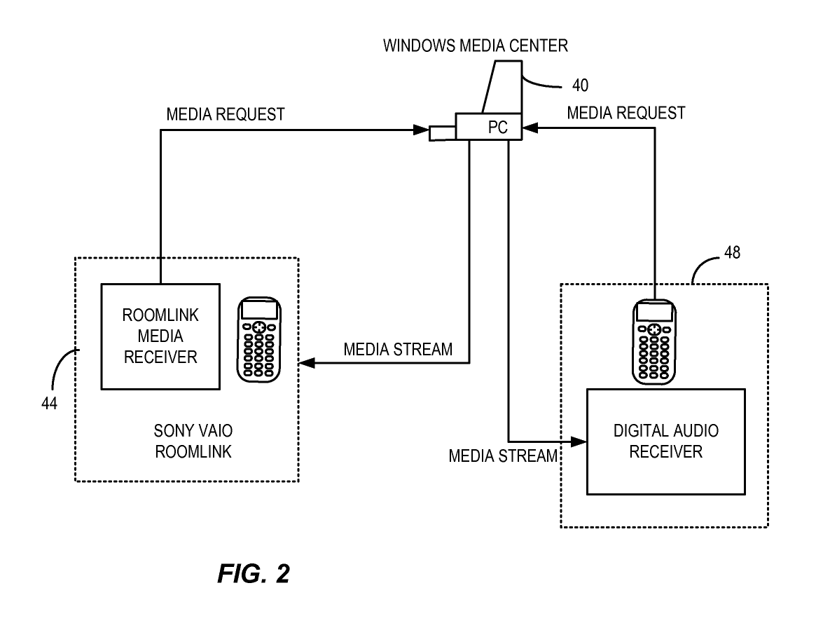

In a WMDRM system, there is another protocol, WMDRM for Network Devices (WMDRM-ND), which extends the reach of protected content to consumer electronic devices, such as digital media receivers (hereinafter referred to as Receivers), that are connected to transmitting devices (such as personal computers) over home Internet protocol (IP) networks. Windows Media DRM for Network Devices enables these Receivers to render protected content while enforcing the rights specified by the content owner. FIG. 2 shows how WMDRM-ND devices stream protected contents.

In this illustration, the Windows™ Media Center 40 receivers media requests from example devices such as a digital audio receiver 44 or a Sony VAIO™ RoomLink™ 48 device and the Windows Media Center responds by providing media streams.

In the example shown for Sony Corporation's 2009 Bravia™ DTV platform, only WMDRM-PD is supported, but this should not be considered limiting on implementations consistent with embodiments of the present invention.

### A. Encryption Basics

Symmetric key algorithms are a class of algorithms for cryptography that use trivially related, often identical, cryptographic keys for both decryption and encryption. Symmetric key algorithms are usually small and fast. Typically, the bulk of any encryption task will be handled by some form of symmetric key encryption.

Public key cryptography, on the other hand, uses a published “public” key to encrypt, and a different, secret, “private” key to decrypt. Public key cryptography requires large algorithms that are computationally complex. A message encrypted with a recipient's public key cannot be decrypted by anyone except a possessor of the matching private key—presumably, this will be the owner of that key and the person associated with the public key used. This is used for confidentiality.

Protected Advanced Streaming Format (ASF) files use symmetric key cryptography to encrypt the bulk of content. Public key cryptography is then used within the license. The license contains the contents' symmetric key. Interpreting the license is thus long and computationally intensive. Once the license has been properly handled, the symmetric key is decrypted, and the content may be decrypted using small and fast algorithms.

### B. Advanced Systems Format (ASF) File

In general, Windows Media DRM is content-agnostic. That is, the ideas and code required to “license and decrypt” content may be theoretically applied to a wide variety of content types—streaming and downloaded. But usually WMDRM is only applied to files in ASF format.

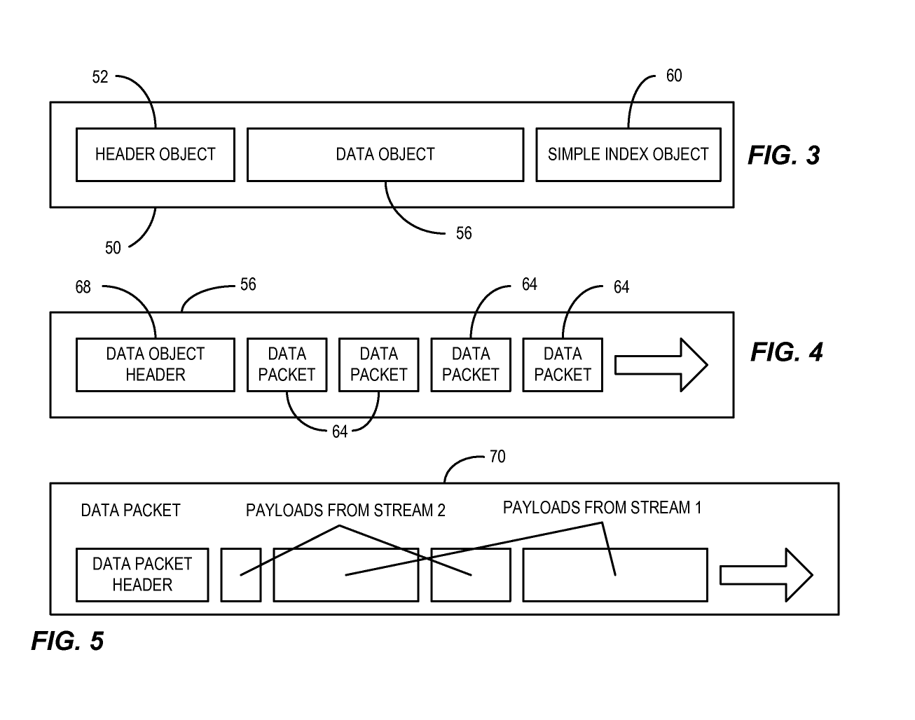

An ASF file 50, as depicted in FIG. 3, normally contains three parts, Header Object 52, Data Object 56 and Simple Index Object 60. FIG. 1 shows the structure of an ASF file. The role of the Header Object is to provide a well-known byte sequence at the beginning of ASF files and to contain all the information that is needed to properly interpret the information within the data object. The Data Object contains all the digital media data for an ASF file. The Simple Index Object contains a time-based index of the video data in an ASF file for trick play. In a protected ASF file, header object and simple index object are always clear.

Data Object contains all of the Data Packets 64 for a file. These Data Packets can contain interleaved data from several digital media streams. This data can be made up of entire objects from one or more streams. Alternatively, it can be made up of partial objects (fragmentation). FIG. 4 shows an example Data Object structure of an ASF file 56. The Data Object header 68 is not encrypted. Normally data packet size for the same file is fixed.

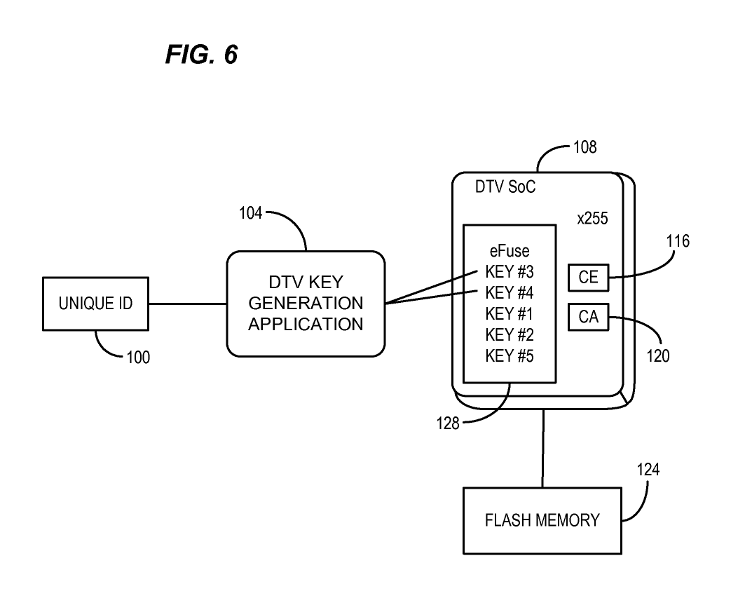

Packets are organized in terms of increasing send times. Data contained in Data Packets 70 are called payloads, and payloads in a Data Packet may come from one stream or multiple streams. FIG. 5 shows structure of a Data Packet FIG. 6 illustrates that payloads from multiple streams may be contained in the same data packet.

### C. Payload Encryption

WMDRM-protected file decryption is done payload by payload. Some of the advantages of this are:

Buffer only required to be large enough to hold one payload

Clear file is never entirely present in memory

Usage may begin when first packet is decrypted

Allows streaming—entire file does not need to be present on system

Fault-tolerant. Dropping a packet glitches, but doesn't affect encryption of other packets

Fast-forward and rewind. Users may randomly access any packet and begin usage

Each WMDRM-protected ASF file is protected by a single symmetric key called the Content Key (Ck). Using the same key over and over for each packet would create a significant cryptographic vulnerability in the system. Because of this, each payload generally uses a unique key. This extra key is stored in the last eight bytes of a payload. This extra key is encrypted under the Content Key (Ck). The actual content (payload) is encrypted or decrypted using the RC4 shared stream cipher and there is no increase in payload length after encryption or decryption.

Processing overhead of the ASF file is similar to that of SSL. On Sony Corporation's Bravia™ 2009 DTV platform, a 1.5 Mbits/second stream uses approximately 20-30% of the MIPS CPU operating at 450 MHz. Processing a 6 Mbits/second stream requires around 80-90% of the processing power. Processing includes parsing and demultiplexing the A/V content and sending each to their respective hardware decoders.

### Discussion on Security

WMDRM-protected files can be distributed on CD or on the Internet without any restriction. A user has to obtain a license before he can use any content.

After performing payment or signing onto a server, the media player sends a file (challenge) with other credential data to the license server to request a license. This challenge contains a video to play and a device certificate. After the license server verifies the authorization, a license is generated and encrypted using the device public key. Only the targeted device can decrypt this license and extract the content key to decrypt the content.

Obtaining the device private key, a hacker could descramble all licenses downloaded to the device and steal all media contents played on this device. It is therefore desirable to achieve the security of the device private key.

Several attack models can be conceived against WMDRM:

Naïve: not an active attacker: will copy files, install hacked programs, etc.

Skilled: active attacker: knows computers and software, no commercial motivation

Professional Pirate: commercially motivated, has funds to mount attacks, hire hackers, reverse engineer, etc.

Given the above attack models, WMDRM has the following security objectives:

Stop the naive attacker from inadvertently bypassing digital rights management

Make it more difficult and costly for the skilled attacker to compromise WM DRM

Minimize scope of break(s) by professional attackers to limit commercial opportunities

### IV. A Solution for Security

Digital television receivers are increasingly using SoC devices to carry out audio and video decoding as well as other operations including decryption and conditional access functions. One series of exemplary SoC circuits used in digital TV receivers is the Broadcom Xilleon series processors such as the proprietary x255. This circuit contains a security processor similar to the Broadcom BCM7041/BCM7402 C0/C1series of devices which are commercially available. Similar circuits are commercially available from other providers that carry out similar functions.

The Broadcom x255 does not have a dedicated CPU for security, but it does have a hardware cipher engine (CE). Additionally, there is an electronic fuse (eFuse) a memory on which five secret encryption/decryption keys can be burned in at the factory which serves as a trusted authority that burns the eFuse. Applications can use keys in the eFuse to do encryption or decryption, but in accord with implementations consistent with embodiments of the present invention, they would not be used to directly read the keys.

In an example implementation, two key slots were used in the eFuse for DRM usage. The question then arises as to how should the keys be generated for these two key slots which will be burned into the eFuse? If the keys are generated randomly and burned on the chip in chip manufacturers (Broadcom) factory, nobody can know what keys are burned on the chip after the chip is out of the factory. Keys generated in this way are unique per device and good enough to be used to protect the WMDRM private key on the device. But a better way has been devised to generate these keys as follows. For each production chip, there is a chip unique serial number that can serve as a unique id and used as a seed to generate two keys for each chip. FIG. 6 shows generation of two keys used for DRM or other security purposes.

In FIG. 6, the unique device ID 100 is passed to a software or firmware or hardware application 104 that converts the unique device ID into a pair of DTV Keys, which in this example are stored in eFuse 128 of the DTV SoC 108 at positions number 3 and number 4.

A server such as the Sony BIVL™ server or other suitable network server can query a DTV device to get the chip id, which means that the two keys burned on DTV SoC chip 108 can be regenerated on the server side using the same key generation process as that used at 104. These two keys or their derivatives can not only be used for local data security, but also for authorization, secure communication, etc. FIG. 6 further depicts the SoC 108 having cipher engine (CE) 116 and Conditional Access processing (CA) 120.

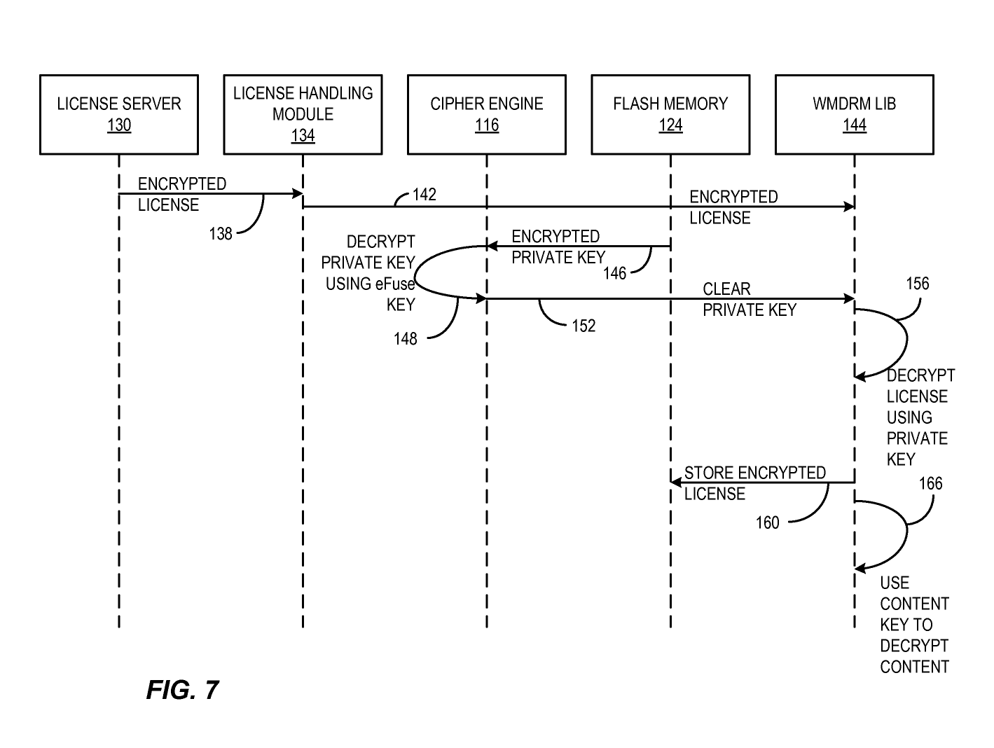

When the DTV does a software upgrade using any suitable technique such as download, the software image is securely downloaded and copied to flash memory 124. On first time launch of the TV application, the WMDRM private key is extracted, and re-encrypted with one of the eFuse keys, then stored in the flash memory 124 for later use. FIG. 7 shows how WMDRM private key is used to decrypt a license.

In this example as depicted in FIG. 7, the license server 130 sends (upon request and suitable payment or other confirmation) an encrypted license to the DTV's license handling module 134 (which may be implemented as software running on one or more programmed processors) at 138. The license handling module 134 then sends the encrypted license at 142 to the WMDRM LIB service module 144 which takes care of license related issues (e.g., challenge generation; communication with license server; following rules set in a license such as expiration, play count, etc.; decryption of payload; etc.). The encrypted private key stored in flash memory 124 is then retrieved at 146 by the cipher engine 116 where it is decrypted at 148 using the secret key stored in the eFuse. The cipher engine 116 is thus able, at 152 to produce a clear private key that is sent to the WMDRM LIB 144. At 156, the license is decrypted at the WDRM LIB 144 using the private key and the license can then be stored to flash memory 124 at 160. The content key is then available at 166 for use in decrypting the content.

On a device, most of the time WMDRM private key is scrambled and resides on the flash memory 124. Only when the media player is to play a protected content, scrambled WMDRM private key will be retrieved and be decrypted. The clear private key is used to extract the related license from a Hashed Data Store if it is available there or decrypt a license just downloaded from a license server. So the clear WMDRM private key is only exposed in memory for a very short time.

As a result, WMDRM-PD can be implemented on DTV for use in, for example, decrypting premium content such as that provided by Netflix™ in an Internet Protocol (IP) TV environment. While Windows WMDRM-PD is used as the example DRM in the present implementation, the present teachings may be applicable to other DRM systems.

Thus, in certain implementations, a method of decrypting Windows Media Digital Rights Management (WMDRM) encoded content in a digital television (DTV) receiver involves receiving an encrypted license from a license server at the DTV receiver; providing a unique identifier for an integrated DTV System on a Chip (SoC) forming a part of the DTV television receiver; storing a secret key in an electronic fuse memory forming a part of the integrated DTV receiver SoC, where the secret key is generated using an algorithm that utilizes the unique identifier for the DTV receiver SoC; where the received encrypted license is encrypted using the same secret key as is stored in the electronic fuse memory; decrypting the secret key using the key stored in the electronic fuse memory to produce a clear secret key; decrypting the encrypted license using the clear secret key to determine a content key; storing the license; and decrypting the WMDRM encoded content using the content key.

In certain implementations, the secret key stored in the electronic fuse memory is one of a plurality of secret keys stored in the electronic fuse memory. In certain implementations, the WMDRM comprises a WMDRM for portable devices. In certain implementations, the license is received via an Internet connection using Direct License Acquisition. In certain implementations, the license is received as a result of a license request for a specific item of content. In certain implementations, the license is encrypted by the license server upon receipt of a query for the unique identifier. In certain implementations, two secret keys are stored in the electronic fuse memory, and where the two keys are generated using the algorithm that utilizes the unique identifier for the DTV receiver SoC. In certain implementations, the license is encrypted using the same two keys generated by use of the same algorithm at the license server along with the unique identifier. In certain implementations, the WMDRM private key is encrypted using a secret key stored in the electronic fuse memory and then stored in encrypted form in a flash memory. In certain implementations, the WMDRM private key is encrypted using a secret key stored in the electronic fuse memory and then stored in encrypted form in a flash memory as a part of a software update process.

In another implementation consistent with the present invention, one or more tangible non-transitory storage media storing instructions that when executed on one or more programmed processors carry out a method of decrypting Windows Media Digital Rights Management (WMDRM) encoded content in a digital television (DTV) receiver, including receiving an encrypted license from a license server at the DTV receiver; providing an unique identifier for an integrated DTV System on a Chip (SoC) forming a part of the DTV television receiver; storing a secret key in an electronic fuse memory forming a part of the integrated DTV receiver SoC, where the secret key is generated using an algorithm that utilizes the unique identifier for the DTV receiver SoC; where the received encrypted license is encrypted using the private key as is encrypted with the secret key in the electronic fuse memory; decrypting the private key using the secret key stored in the electronic fuse memory to produce a clear private key; decrypting the encrypted license using the clear private key to determine a content key; storing the license; and decrypting the WMDRM encrypted content using the content key.

In certain implementations, the private key stored in the electronic fuse memory is one of a plurality of private keys stored in the electronic fuse memory.

A digital television receiver consistent with certain implementations decrypts Windows Media Digital Rights Management (WMDRM) encrypted content and has a receiver that receives an encrypted license from a license server. An integrated DTV System on a Chip (SoC) has a unique identifier and forms a part of the DTV television receiver. The SoC has an electronic fuse memory. A secret key is stored in the electronic fuse memory, where the secret key is generated using an algorithm that utilizes the unique identifier for the DTV receiver SoC. The received encrypted license is encrypted using the private key as is encrypted with the secret key in the electronic fuse memory. A cipher engine decrypts an encrypted private key stored on a flash memory using the secret key stored in the electronic fuse memory to produce a clear private key. A processor is provided. A WMDRM Library Service runs on the processor and decrypts the encrypted license using the clear private key to determine a content key, and decrypts the WMDRM encrypted content using the content key.

In certain implementations, the secret key stored in the electronic fuse memory is one of a plurality of keys stored in the electronic fuse memory. In certain implementations, the WMDRM comprises a WMDRM for portable devices. In certain implementations, the license is received via an Internet connection using Direct License Acquisition. In certain implementations, the license is received as a result of a license request for a specific item of content. In certain implementations, the license is encrypted by the license server upon receipt of a query for the unique identifier. In certain implementations, two private keys are stored in the electronic fuse memory, and where the two keys are generated using the algorithm that utilizes the unique identifier for the DTV receiver SoC. In certain implementations, the WMDRM private key is encrypted using a secret key stored in the electronic fuse memory and then stored in encrypted form in a flash memory. In certain implementations, the WMDRM private key is encrypted using a secret key stored in the electronic fuse memory and then stored in encrypted form in a flash memory as a part of a software update process.

In another method of decrypting Digital Rights Management (DRM) encoded content in a digital television (DTV) receiver involves receiving an encrypted license from a license server at the DTV receiver; providing a unique identifier for an integrated DTV System on a Chip (SoC) forming a part of the DTV television receiver; storing a secret key in an electronic fuse memory forming a part of the integrated DTV receiver SoC, where the secret key is generated using an algorithm that utilizes the unique identifier for the DTV receiver SoC; where the received encrypted license is encrypted using the same secret key as is stored in the electronic fuse memory; decrypting the secret key using the key stored in the electronic fuse memory to produce a clear secret key; decrypting the encrypted license using the clear secret key to determine a content key; storing the license; and decrypting the DRM encoded content using the content key.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

While certain embodiments herein were described in conjunction with specific circuitry such as the DTV SoC that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

While certain illustrative embodiments have been described, it is evident that many alternatives, modifications, permutations and variations will become apparent to those skilled in the art in light of the foregoing description.

What is claimed is:

1. A method of decrypting Digital Rights Management (DRM) encoded content in a digital television (DTV) receiver, comprising:
receiving an encrypted license from a license server at the DTV receiver;
providing a unique identifier for an integrated DTV System on a Chip (SoC) forming a part of the DTV television receiver;
storing a secret key in an electronic fuse memory forming a part of the integrated DTV receiver SoC, where the secret key is generated using an algorithm that utilizes the unique identifier for the DTV receiver SoC;
where the received encrypted license is encrypted using the same secret key as is stored in the electronic fuse memory;
decrypting the secret key using the key stored in the electronic fuse memory to produce a clear secret key;
decrypting the encrypted license using the clear secret key to determine a content key;
storing the license; and
decrypting the DRM encoded content using the content key.

2. The method according to claim 1, where the secret key stored in the electronic fuse memory is one of a plurality of secret keys stored in the electronic fuse memory.

3. The method according to claim 1, where the DRM comprises a DRM for portable devices.

4. The method according to claim 1, where the license is received via an Internet connection using Direct License Acquisition.

5. The method according to claim 1, where the license is received as a result of a license request for a specific item of content.

6. The method according to claim 1, where the license is encrypted by the license server upon receipt of a query for the unique identifier.

7. The method according to claim 1, where two secret keys are stored in the electronic fuse memory, and where the two keys are generated using the algorithm that utilizes the unique identifier for the DTV receiver SoC.

8. The method according to claim 7, where the license is encrypted using the same two keys generated by use of the same algorithm at the license server along with the unique identifier.

9. The method according to claim 1, where the DRM private key is encrypted using a secret key stored in the electronic fuse memory and then stored in encrypted form in a flash memory.

10. The method according to claim 9, where the DRM private key is encrypted using a secret key stored in the electronic fuse memory and then stored in encrypted form in a flash memory as a part of a software update process.

11. One or more tangible non-transitory storage media storing instructions that when executed on one or more programmed processors carry out a method of decrypting Digital Rights Management (DRM) encoded content in a digital television (DTV) receiver, comprising:
receiving an encrypted license from a license server at the DTV receiver;
providing an unique identifier for an integrated DTV System on a Chip (SoC) forming a part of the DTV television receiver;
storing a secret key in an electronic fuse memory forming a part of the integrated DTV receiver SoC, where the secret key is generated using an algorithm that utilizes the unique identifier for the DTV receiver SoC;
where the received encrypted license is encrypted using the private key as is encrypted with the secret key in the electronic fuse memory;
decrypting the private key using the secret key stored in the electronic fuse memory to produce a clear private key;
decrypting the encrypted license using the clear private key to determine a content key;
storing the license; and
decrypting the DRM encrypted content using the content key.

12. The method according to claim 11, where the private key stored in the electronic fuse memory is one of a plurality of private keys stored in the electronic fuse memory.

13. A digital television receiver that decrypts Digital Rights Management (DRM) encrypted content, comprising:
a receiver that receives an encrypted license from a license server;
an integrated DTV System on a Chip (SoC) having an unique identifier and forming a part of the DTV television receiver;
the SoC having an electronic fuse memory;
a secret key stored in the electronic fuse memory, where the secret key is generated using an algorithm that utilizes the unique identifier for the DTV receiver SoC;
where the received encrypted license is encrypted using the private key as is encrypted with the secret key in the electronic fuse memory;
a cipher engine that decrypts an encrypted private key stored on a flash memory using the secret key stored in the electronic fuse memory to produce a clear private key;
a processor;
a DRM Library Service running on the processor that decrypts the encrypted license using the clear private key to determine a content key, and decrypts the DRM encrypted content using the content key.

14. The receiver according to claim 13, where the secret key stored in the electronic fuse memory is one of a plurality of keys stored in the electronic fuse memory.

15. The receiver according to claim 13, where the DRM comprises a DRM for portable devices.

16. The receiver according to claim 13, where the license is received via an Internet connection using Direct License Acquisition.

17. The receiver according to claim 13, where the license is received as a result of a license request for a specific item of content.

18. The receiver according to claim 13, where the license is encrypted by the license server upon receipt of a query for the unique identifier.

19. The receiver according to claim 13, where two private keys are stored in the electronic fuse memory, and where the two keys are generated using the algorithm that utilizes the unique identifier for the DTV receiver SoC.

20. The receiver according to claim 13, where the DRM private key is encrypted using a secret key stored in the electronic fuse memory and then stored in encrypted form in a flash memory.

21. The method according to claim 20, where the DRM private key is encrypted using a secret key stored in the electronic fuse memory and then stored in encrypted form in a flash memory as a part of a software update process.
